(19) United States
(12) Patent Application Publication
(10) Pub. No.: US 2005/0216327 A1
(43) Pub. Date: Sep. 29, 2005

(54) Authority approval method and system

(75) Inventor: Teng-Hsu Lee, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/013,958

(22) Filed: Dec. 16, 2004

(30) Foreign Application Priority Data
Dec. 17, 2003 (TW) 92135705

(51) Int. Cl. G06F 17/60

(52) U.S. Cl. 705/9

(57) ABSTRACT

An authority approval method and system. A staff organization diagram is first created. An approval sheet is created according to the staff organization diagram and an approval process, and the approval sheet is given at least one approval layer, governed by an approval manager. Approvable terms of the approval sheet are determined according to the approval process. Finally, at least one approval manager is deployed at each approval layer of the approval sheet.

### BACKGROUND

The invention relates to data authorization, and in particular to an authority approval method and system.

Currently, authority approval processes are widely used in enterprise for procedures, such as requesting a leave, purchasing, sales, and the like. Conventionally, an approval plan is implemented and managed by staff, which is time-consuming. Additionally, approval deadlines for a plan may expire before the approval procedure is complete.

Recently, authority approval processes have been computerized. Approval plans have been transferred into digital form for use in computer systems. Approval processes, however, in departments of an enterprise are independent and multiple approval sheets from one department may be in process at the same time, resulting in duplicated effort. Further, approval policies applied to computer systems can only be modified by system administrators, meaning, managers cannot modify approval policies as required. Thus, an improved method for authority approval is desirable.

### SUMMARY

Accordingly, the invention provides an authority approval method, system and computer readable storage medium for simplifying approval processes and enabling authority approval determination and manager alteration.

The invention further provides an authority approval method, system and computer readable storage medium for deploying managers of each approval layer and determining authority approval levels of each approval manager for cross-organization or cross-department.

Accordingly, the authority approval method of the invention includes the steps hereunder. A staff organization diagram is first generated. An approval sheet is generated according to the staff organization diagram and an approval process. The approval sheet is given at least one approval layer, governed by an approval manager. Approvable terms of the approval sheet are determined according to the approval process. Finally, at least one approval manager is deployed at each approval layer of the approval sheet.

The invention further provides a system for authority approval, comprising a data generating unit, a table generating unit, a data setting unit, and a staff deploying unit. The data generating unit generates a staff organization diagram. The table generating unit generates an approval sheet according to the staff organization diagram and an approval process, the approval sheet then given at least one approval layer. The data setting unit determines approvable terms of the approval sheet according to the approval process. The staff deploying unit deploys at least one approval manager at each approval layer of the approval sheet.

A computer readable storage medium storing a computer program providing a method for authority approval, comprising using a computer to perform the steps of creating a staff organization diagram comprising data and authority approval levels of the staff, wherein the staff organization diagram is a tree diagram, displaying staff belonging to different authority approval levels; creating an approval sheet according to the staff organization diagram and an approval process, wherein the approval sheet is given at least one approval layer, governed by at least one approval manager; determining approvable terms of the approval sheet according to the approval process; and deploying at least one approval manager at each approval layer of the approval sheet.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a flowchart of the authority approval method of an embodiment of the invention;

FIG. 2 is a schematic diagram of an approval sheet of an embodiment of the invention; and

FIG. 3 is a schematic diagram of the architecture of the authority approval system according to an embodiment of the invention.

### DETAILED DESCRIPTION

Embodiments of the invention disclose an authority approval method and system.

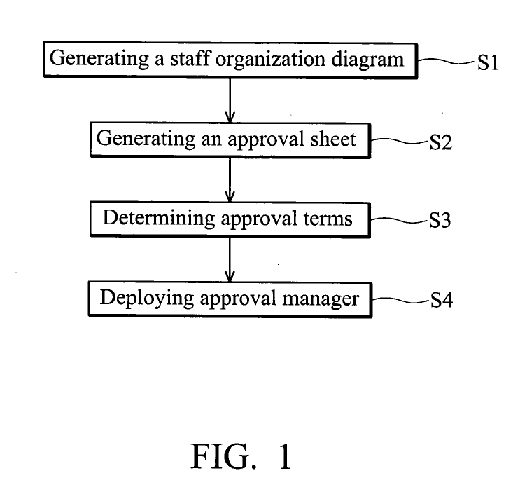

FIG. 1 is a flowchart of the authority approval method of an embodiment of the invention.

In step S1, a staff organization diagram, comprising data and authority approval levels of the staff, is generated. The staff organization diagram is a tree diagram, displaying staff members belonging to different authority approval levels. In this embodiment, a human resource system and a single sign-on system are integrated, merging sign-on authorization of multiple organizations (or departments) and authority approval of multiple electronic sheets (or programs), enabling single login for sharing system resources in different systems. Additionally, multiple objects, such as departments, electronic sheet, or programs, are allowed to share the unique authority approval.

In step S2, an approval sheet is created according to the staff organization diagram and an approval process. Each approval sheet is given at least one approval layer and each approval layer is governed by at least one approval manager. Managers of each layer can modify authority approval levels thereof, or change the managers in sub-layers.

In step S3, approvable terms applied to the approval sheet are determined according to the approval process.

In step S4, at least one approval manager is deployed at each approval layer of the approval sheet. The approval manager changes, registers, or dismisses managers of each approval layer, thus creating the approval sheet.

The described steps can be implemented by an authority administrator, the system developer, or an approval program in accordance with approval routines and an approval database. Additionally, the staff organization diagram can merge multiple organizations and provides different authority approval levels.

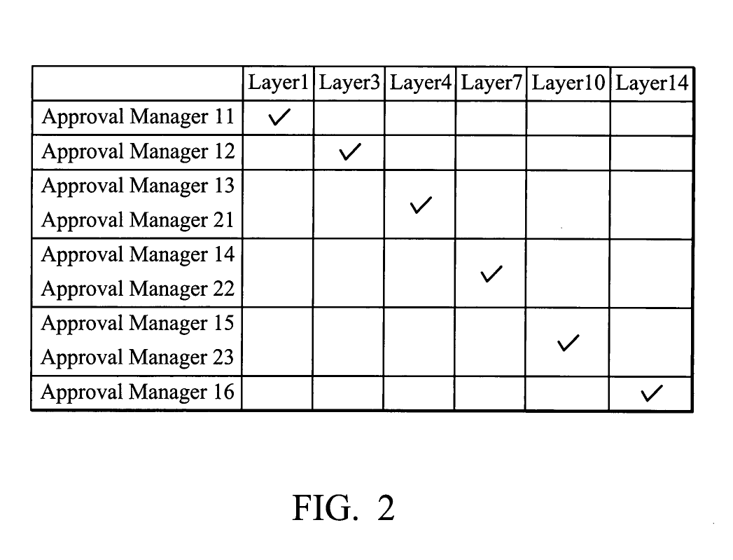

First and second organizations, for example, comprise several departments respectively, all the departments combined provide 14 approval layers in an approval system, with layer 1 having the lowest authority approval level to layer 14 having the highest authority approval level. As shown in FIG. 2, layer 1, layer 3, layer 4, layer 7, layer 10, and layer 14 must be approved for a procedure, such as requesting a leave, in which approval managers of each layer are registered by the approval administrator when creating the approval sheet. Layer 1 is governed by an approval manager 11 of the first organization. Layer 3 is governed by an approval manager 12 of the first organization. Layer 4 is governed by an approval manager 13 of the first organization and an approval 21 of the second organization. Layer 7 is governed by an approval manager 14 of the first organization and an approval manager 22 of the second organization. Layer 10 is governed by an approval manager 15 of the first organization and an approval manager 23 of the second organization. Layer 14 is governed by an approval manager 16 of the first organization.

Next, approval terms are determined according to the approval process. Approval managers of each layer can be deployed by an approval administrator, changing, registering, or dismissing the managers of each approval layer.

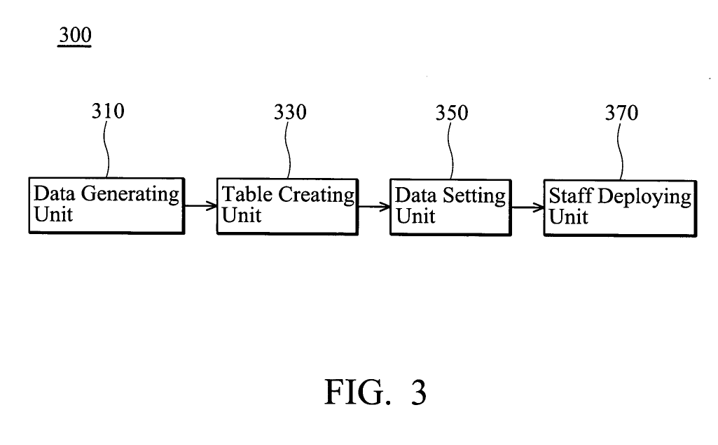

FIG. 3 is a schematic diagram of the architecture of the authority approval system according to an embodiment of the invention. The system comprises a data generating unit 310, a table generating unit 330, a data setting unit 350, and a staff deploying unit 370.

Data generating unit 310 generates a staff organization diagram, comprising data and authority approval levels of the staff and integrating multiple organizations providing different authority approval levels. Table generating unit 330 generates an approval sheet according to the staff organization diagram and an approval process. Each approval sheet is given at least one approval layer and each approval layer is governed by at least one approval manager.

Data setting unit 350 determines approvable terms applied to the approval sheet according to the approval process. Finally, staff deploying unit 370 deploys at least one approval manager at each approval layer, changing, registering, or dismissing the managers of each approval layer, and the approval sheet is thus created.

Embodiments of the invention simplify approval processes and enable approval managers with higher authority approval levels to determine and manage levels of authority. Embodiments of the invention additionally deploy managers of each approval layer and determine authority approval levels of each approval manager for cross-organization or cross-department

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for authority approval, comprising:
generating a staff organization diagram;
generating an approval sheet according to the staff organization diagram and an approval process, wherein the approval sheet is given at least one approval layer, governed by at least one approval manager;
determining approvable terms of the approval sheet according to the approval process; and
deploying at least one approval manager at each approval layer of the approval sheet.

2. The method as claimed in claim 1, wherein multiple organizations providing different authority approval levels are integrated to generate the staff organization diagram.

3. The method as claimed in claim 1, wherein organizations using different approval applications are integrated to form the staff organization diagram, wherein each approval application must be approved.

4. The method as claimed in claim 1, wherein the staff organization diagram comprises data and authority approval levels of the staff.

5. The method as claimed in claim 1, wherein the staff organization diagram is a tree diagram, displaying staff belonging to different authority approval levels.

6. The method as claimed in claim 1, wherein input data is acquired from an approval manager, the approval sheet is given at least one approval layer and each approval layer is given an authority approval level of at least one approval manager accordingly.

7. The method as claimed in claim 1, wherein after manager deployment, input messages are acquired from an approval manager with a higher authority approval level for modifying the authority approval level thereof, and approval managers of each approval layer are changed accordingly.

8. The method as claimed in claim 1, wherein after manager deployment, input messages are acquired from an approval manager with a higher authority approval level for modifying authority approval levels of approval managers with lower levels, and approval managers of each approval layer are changed accordingly.

9. A system for authority approval, comprising:
a data generating unit for generating a staff organization diagram;
a table generating unit for generating an approval sheet according to the staff organization diagram and an approval process, wherein the approval sheet is given at least one approval layer, governed by at least one approval manager;
a data setting unit for determining approvable terms of the approval sheet according to the approval process; and
a staff deploying unit for deploying at least one approval manager at each approval layer of the approval sheet.

10. The system as claimed in claim 9, wherein the data generating unit integrates multiple organizations providing different authority approval levels to generate the staff organization diagram.

11. The system as claimed in claim 9, wherein the data generating unit integrates organizations using different approval applications to form the staff organization diagram, wherein each approval application must be approved.

12. The system as claimed in claim 9, wherein the staff organization diagram comprises data and authority approval levels of the staff.

13. The system as claimed in claim 9, wherein the staff organization diagram is a tree diagram, displaying staff belonging to different authority approval levels.

14. The system as claimed in claim 9, wherein the staff deploying unit acquires input data from an approval manager, defining the approval sheet by at least one approval layer and each approval layer by an authority approval level of at least one approval manager accordingly.

15. The system as claimed in claim 9, wherein after manager deployment, the staff deploying unit acquires input messages from an approval manager with a higher authority approval level for modifying the authority approval level thereof, and changes approval managers of each approval layer accordingly.

16. The system as claimed in claim 9, wherein after manager deployment, the staff deploying unit acquires input messages from an approval manager with a higher authority approval level for modifying authority approval levels of approval managers with lower levels, and changes approval managers of each approval layer accordingly.

17. A computer readable storage medium storing a computer program providing a method for authority approval, comprising using a computer to perform the steps of:
creating a staff organization diagram comprising data and authority approval levels of the staff, wherein the staff organization diagram is a tree diagram, displaying staff belonging to different authority approval levels;
creating an approval sheet according to the staff organization diagram and an approval process, wherein the approval sheet is given at least one approval layer, governed by at least one approval manager;
determining approvable terms of the approval sheet according to the approval process; and
deploying at least one approval manager at each approval layer of the approval sheet.

18. The storage medium as claimed in claim 17, wherein multiple organizations providing different authority approval levels or organizations using different approval applications are integrated to create the staff organization diagram, wherein each approval application must be approved.

19. The storage medium as claimed in claim 17, wherein input data is acquired from an approval manager, the approval sheet is given at least one approval layer and each approval layer is given an authority approval level of at least one approval manager accordingly.

20. The storage medium as claimed in claim 17, further comprising:
input messages are acquired from an approval manager with a higher authority approval level for modifying the authority approval level thereof, and approval managers of each approval layer are changed accordingly, and
input messages are acquired from an approval manager with a higher authority approval level for modifying authority approval levels of approval managers with lower levels, and approval managers of each approval layer are changed accordingly.
